(19) United States
(12) Patent Application Publication
(10) Pub. No.: US 2002/0090918 A1
(43) Pub. Date: Jul. 11, 2002

(54) Phone connector assembly

(76) Inventor: Michael B. Grimm, Skokie, IL (US)

Correspondence Address: DILLIS V. ALLEN, Suite 205, 1080 Nerge Road, Elk Grove Village, IL, 60007, US

(21) Appl. No.: 09/755,802

(22) Filed: Jan. 6, 2001

(51) Int. Cl. H04B 1/38

(52) U.S. Cl. 455/90; 455/347; 455/348; 379/428.04; 379/428.01

(57) ABSTRACT

A phone connector assembly for cellular phones that lack locking connector capability, including a cup-shaped member for cradling the phone having a base at one end with terminal contact pins, and a flexible retainer at the other end which snap-locks into a recess in the top of the phone and holds the phone securely in the cup-shaped member.

### BACKGROUND OF THE INVENTION

Many cellular phones, while having external contacts to internal circuitry, are not designed to be lockingly connected to external devices such as hand-free systems or charging devices. This is because they are not designed to receive locking-type connectors or they have no capability for alternatives to locking connectors.

It is a primary object of the present invention to provide an assembly that allows the quick connect and disconnect to a phone and which has the capability of being incorporated into existing phone mounting mechanisms.

### SUMMARY OF THE PRESENT INVENTION

In accordance with the present invention, a phone connector assembly is provided for cellular phones that lack locking connector capabilities including a cup-shaped member for cradling the phone and having a base at one end with terminal contact pins and a flexible retainer member at the other end which snap-locks into a recess on the top of the phone to hold the phone in the cup-shaped member and securely against the contact pins. The phone is slid into the cup flexing the retainer and after the phone is engaged against the terminal pins, the retainer is snap-locked into a recess at the top of the phone.

Toward these ends, the base is molded as a separate piece from the cup member to facilitate testing the base contact pins by the manufacturer, and thus rejection of a base does not result in an attendant rejection of the cup member or the retainer.

The retainer clips to the cup member and permits the entire assembly to be packaged with the retainer detached, thereby significantly reducing packaging size.

Furthermore, the retainer has a flexible tab or detent that snap-locks into the top of the phone and this tab is subject to wear. Because the retainer is removable, it can be easily replaced by the user without replacing the entire assembly.

The phone cup member has a cross bar with a recess that orthogonally aligns the retainer as it is clipped to the cross bar.

This cross bar is at the top of the cup member, permitting the rear of the cup member to be open, accommodating different phone shapes and battery sizes.

The base has an integral wire enclosing sheath, sometimes referred to as a strain relief, eliminating the normal technique of forming the strain relief as a separate part or piece.

Finally, the terminal contact pins are mounted in a terminal block that is insert-molded into the base. This results in more accurate positioning of the contact pins during manufacture and removes the need for post-gluing of the wire in the strain relief and housing. It also simplifies soldering the leads to the contacts and decreases manufacturing time while improving total product quality.

Overall, this multiple piece phone connector assembly provides improved quality, manufacturing, assembly, usability, packaging and customization.

Other objects and advantages of the present invention will appear more clearly from the following detailed description.

### BRIEF DESCRIPTION OF THE DRAWINGS

FIG. 1 is a top left perspective of the present phone connector assembly with a cellular phone shown in dotted lines;

FIG. 2 is an exploded view of the phone connector assembly illustrated in FIG. 1;

FIG. 3 is a longitudinal section of the phone connector assembly taken mid-line through FIG. 1;

FIG. 4 is a top view of the phone connector assembly illustrated in FIGS. 1 to 3;

FIG. 5 is a bottom view of the phone connector assembly illustrated in FIGS. 1 to 4;

FIG. 6 is an exploded view of the base subassembly, and;

FIG. 7 is a bottom perspective of the base illustrated in FIG. 6.

### DETAILED DESCRIPTION OF THE PREFERRED EMBODIMENT

Referring to the drawings, a phone connector assembly 10 is illustrated in accordance with the present invention consisting of three basic components: a base 11, a phone cup member 12 for cradling the phone, and a retainer 14 for holding the phone in the cup member 12 against contact pins 16 in a terminal block 17 insert molded into base 11

All three of the pieces, namely; the base 11, the cup member 12, and the retainer 14 are separate injection molded thermoplastic parts.

As seen in FIGS. 6 and 7, the base 11 is generally rectangular in configuration and includes a rectangular block portion 20 into which terminal block 17 is insert molded, and a pair of arcuate portions 21 and 22 that receive pins 24, as seen in FIG. 2, projecting downwardly from the cup member 11. The base member 11 has horizontal surfaces 25 that provide abutments on the base 11 for lower surfaces 26 and 27 on the cup-shaped member 12.

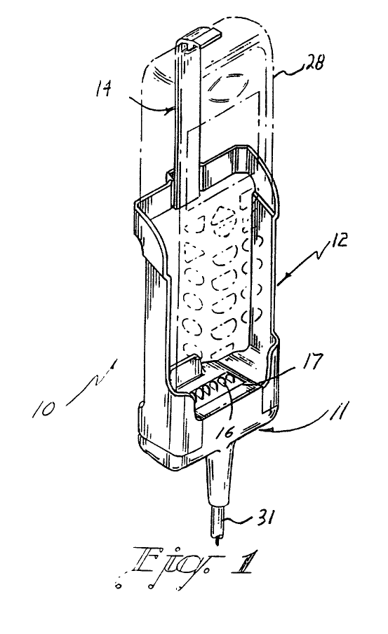

As noted above, the insert molding of the terminal block 17 in the base 11 provides improved alignment and positioning of contact pins 16 relative to the corresponding contacts on the lower surface of phone 28 illustrated in FIG. 1.

The base 11 has an annular sheath 29 integrally molded with the base 11 that provides a strain relief for cable or wire 31 illustrated in FIG. 1, that connects the phone through contact pins 16 to a peripheral system such as a charging system or hands-free system.

The cup member 12 essentially acts as a cradle for the phone in holding the phone terminals against the contact pins 16 and includes a generally horizontal bottom portion 33 with a rectangular cut-out 34 for receiving base block portion 20 and upstanding spaced parallel integral arm portions 35 and 36 that engage the sides of the phone 28. The upper ends of the arms 35 and 36 have outwardly stepped portions 38 and 39 that bend to the rear of the cup-shaped member 12 and are interconnected by a cross bar 42 that has a recess portion 43 that engages the sides of the retainer member 14 to orthogonally align the retainer member.

As seen in the drawings and particularly FIG. 2, the cup member 14 has a large rear opening 45 that accommodates different phone configurations and different battery sizes.

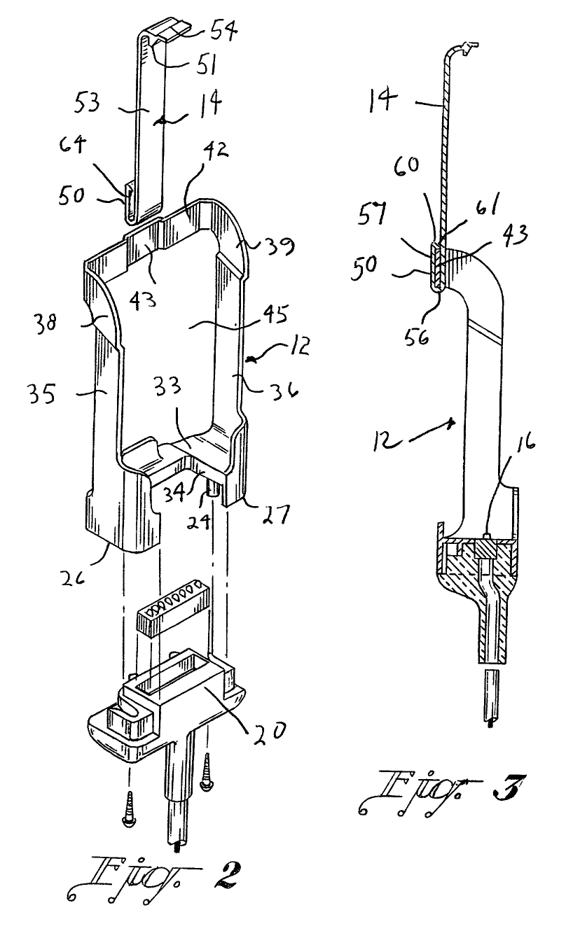

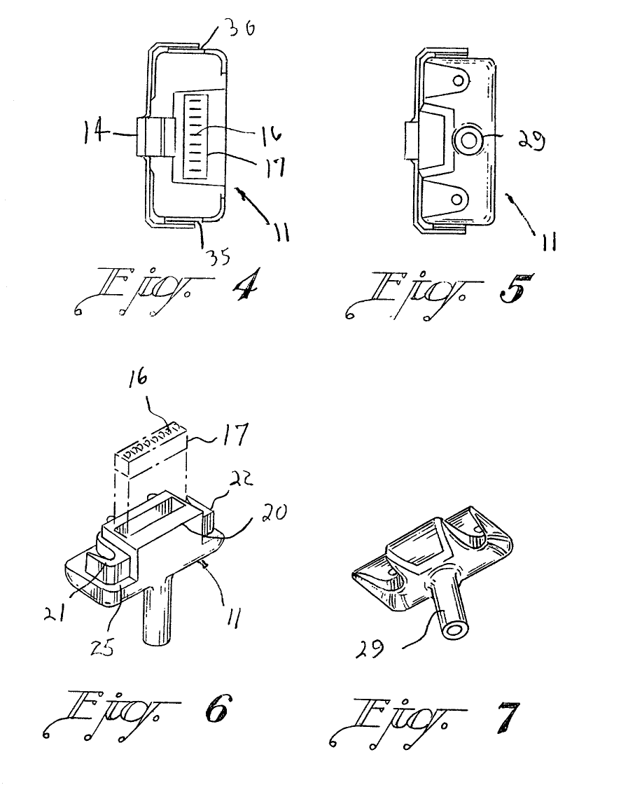

The retainer 14 is essentially an elongated member having a clip 50 at its lower end that snaps over recess portion 43 and a detent or tab 51 at its other end that snaps into a recess at the top of the phone as seen in FIG. 1. Retainer member 14 has a straight elongated central portion 53 and a top portion 54 that bends 90 degrees with respect to central portion 53 and carries the tab or detent 51 which tapers convergingly downwardly as seen clearly in FIGS. 2 and 3.

As seen in FIG. 3, the clip 50 is flexible and includes a U-shaped portion 56 having an upwardly projecting arm portion 57 with a snap-locking detent 60 at its upper end. The detent 60 has an angular camming surface 61 that cams the arm U-shaped portion 56 open as the retainer is assembled over the cross bar portion 43 from the lower end of the cross bar upwardly, and the clip 50 has a second locking portion 64 that locks over the top of the cross bar 43 as seen in FIG. 3.

As phone is inserted into the cradle, the retainer 14 flexes rearwardly or to the left in FIG. 3 somewhat and the user then pushes the rear top portion of the clip up over the top of the phone which cams the upper portion 54 upwardly somewhat and when the detent 51 passes over the recess in the top of the phone, the arm portion 54 snaps downwardly and the detent 51 locks in the recess in the phone. In this position, the phone is securely held against the contact pins 16, as well as being held in the phone cup member 12.

1. A locking phone connector system for a phone having contacts at one end thereof and an opposite end, comprising:
a base having a terminal member having a plurality of exposed contacts thereon, a phone receiver connected to the terminal member and at least in part encircling the phone,
and means connected to the phone receiver for engaging the phone at the end opposite the phone contacts for holding the phone contacts against the terminal member contacts.

2. A locking phone connector system as defined in claim 1, wherein the terminal member and phone receiver are separate pieces to facilitate the testing of the terminal member.

3. A locking phone connector system as defined in claim 1, wherein the means connecting the phone receiver includes an elongated member having a clip at one end for detachable engagement with the phone receiver.

4. A locking phone connector system as defined in claim 3, wherein said elongated member has a detent at the other end thereof for engagement in a recess in the opposite end of the phone.

5. A locking phone connector system as defined in claim 3, including a recess in the phone receiver for orienting the elongated member in two orthogonal directions.

6. A locking phone connector system as defined in claim 1, wherein the phone receiver is a cup-shaped member having a partly open forward wall for exposing the phone and a partly open rear wall for accommodating various phone configurations.

7. A locking phone connector system as defined in claim 1, wherein the terminal member has an integral protective sheath for a connector wire.

8. A locking phone connector system as defined in claim 1, wherein the terminal member is insert molded in the base.

9. A locking phone connector system for a phone having contacts at one end thereof and an opposite end, comprising:
a base having a terminal member having a plurality of exposed contacts thereon, a phone receiver connected to the terminal member and at least in part encircling the phone,
and an elongated clip connected to the phone receiver having a flexible detent at its distal end selectively engageable in a recess in the opposite end of the phone.

10. A locking phone connector system as defined in claim 9, wherein the phone receiver has a cross bar with a substantially central recess thereon to receive and orthogonally align the elongated clip.

11. A locking phone connector system for a phone having contacts at one end thereof and an opposite end, comprising: a base having a terminal member having a plurality of exposed contacts thereon, a phone receiver connected to the terminal member and at least in part encircling the phone, the phone receiver being a cup-shaped member having a partly open forward wall for exposing the phone and a partly open rear wall for accommodating various phone configurations, and means connected to the phone receiver for engaging the phone at the end opposite the phone contacts for holding the phone contacts against the terminal member contacts.

12. A locking phone connector system for a phone having contacts at one end thereof and an opposite end, comprising: a base having a terminal member having a plurality of exposed contacts thereon, a phone receiver connected to the terminal member and at least in part encircling the phone, means connected to the phone receiver for engaging the phone at the end opposite the phone contacts for holding the phone contacts against the terminal member contacts, the terminal member and phone receiver being separate pieces to facilitate the testing of the terminal member, the terminal member having an integral protective sheath for a connector wire, the terminal member being insert molded in the base.

13. A locking phone connector system for a phone having contacts at one end thereof and an opposite end, comprising: a base having a terminal member having a plurality of exposed contacts thereon, a phone receiver connected to the terminal member and at least in part encircling the phone, and a flexible detent connect to the phone receiver engageable selectively in a recess in the opposite end of the phone.
